(19) United States
(12) Patent Application Publication
(10) Pub. No.: US 2010/0302052 A1
(43) Pub. Date: Dec. 2, 2010

(54) INTELLECTUALIZED POLARITY IDENTIFICATION DEVICE

(75) Inventors: YePing Fan, Shanghai (CN); ZhiLiang Jiang, Shanghai (CN); WeiLing Ma, Shanghai (CN); ZhongRen Zhang, Shanghai (CN)

Correspondence Address: Levenfeld Pearlstein, LLC;Intellectual Property Department, 2 North LaSalle, Suite 1300, Chicago, IL, 60602, US

(73) Assignee: SHANGHAI GUANGWEI ELECTRIC & TOOLS CO., LTD., Shanghai (CN)

(21) Appl. No.: 12/703,174

(22) Filed: Feb. 9, 2010

(30) Foreign Application Priority Data
Jun. 2, 2009 (CN) 200910057353.4

(51) Int. Cl. G08B 21/00; H01H 47/00

(52) U.S. Cl. 340/653; 361/170

(57) ABSTRACT

The invention involves an intellectualized polarity identification device which comprises an electromagnetic module connected with a control circuit. The electromagnetic module comprises a magnetic inductor (electromagnet), a movable contact plate coaxially set with the magnetic inductor (electromagnet) and stationary contact plates. The control circuit comprises a reversed-polarity alarm protecting circuit connected with a correct-polarity conducting circuit. The reversed-polarity alarm protecting circuit comprises an alarm circuit and a protection circuit, the protection circuit comprising a diode and a photocoupler. The correct-polarity conducting circuit comprises a conduction circuit and an indicator circuit, respectively connected with the photocoupler. The intellectualized polarity identification device is electromagnetically controlled such that a closed circuit is created only when the device is connected with the correct polarity.

### BACKGROUND OF THE INVENTION

The present invention relates generally to emergency power supplies, and, more specifically, to an intellectualized polarity identification device which is particularly applicable for use with emergency power supplies for automobiles and other vehicles, for example, such as when jump starting the vehicle or otherwise providing power.

In a typical emergency power supply, the red pole is the anode (“+” or positive) pole and the black pole is the cathode (“−” or negative) pole. Thus, when an emergency power supply is connected, for example, to an automobile car battery using a cable, the red (positive) clamp of the cable is connected to the positive terminal of the battery, and the black (negative) clamp of the cable is connected to the negative terminal of the battery.

If the power supply is accidentally connected in reverse (that is, the red (positive) clamp of the cable is connected to the negative terminal of the battery, and the black (negative) clamp of the cable is connected to the positive terminal of the battery), a short circuit will occur, which may damage the power supply, the battery and any electric devices connected to them.

The prior art has developed protectors designed to provide audible and/or visual alarms to alert a user when a short circuit is created. Some prior art protectors also include manually-controlled high current switches to protect the power supply, the battery and any connected electrical devices.

However, what is needed is a device that automatically protects the power supply, the battery and any connected electrical devices by preventing short circuits from occurring and at the same time providing audible and/or visible alarms to alert the user of a reversed polarity condition. The present invention satisfies these needs.

### BRIEF SUMMARY OF THE INVENTION

The present invention provides an intellectualized polarity identification device, particularly for use with an emergency power supply, that is advantageously configured to automatically protect the emergency power supply and any connected electrical devices by preventing short circuits from occurring due to a reversed polarity condition when connected to an external power supply (a vehicle battery in need of charging, for example) and, also, to provide audible and/or visible alarms to alert a user of the emergency power supply of the reversed polarity condition.

In the disclosed embodiment of the intellectualized polarity identification device of the present invention, the intellectualized polarity identification device is electromagnetically controlled such that a closed circuit between the emergency power supply and the external power supply is created only when the emergency power supply is correctly connected to the positive and negative poles of the external power supply. In that manner, the emergency power supply will provide power to the external power supply only when the polarity of the connection between them is correct.

Additionally, the intellectualized polarity identification device of the present invention is configured with audible and visible alarms such that an audible alert and a first visible light (red) are automatically produced when the polarity between the emergency power supply and the external power supply is reversed, and such that a second visible light (green) (but no first visible light (red) and no audible alert) is automatically produced when the polarity between the emergency power supply and the external power supply is correct.

In the disclosed embodiment, the intellectualized polarity identification device of the present invention comprises an electromagnetic module, a control circuit connected to the electromagnetic module and an internal power supply.

In the disclosed embodiment of the intellectualized polarity identification device of the present invention, the electromagnetic module comprises:

a magnetic inductor (electromagnet), the lead terminals of the magnetic inductor (electromagnet) connected, respectively, to the control circuit, the magnetic inductor (electromagnet) configured to control a propeller or shaft that moves in response to activation of the magnetic inductor (electromagnet);

a movable contact plate, the contact plate coaxially disposed with the propeller or shaft of the magnetic inductor (electromagnet) and configured to move up and down under the control of the propeller or shaft of the magnetic inductor (electromagnet); and,

two stationary contact plates, fixedly disposed on the electromagnetic module, with one plate connected to the anode clamp (the clamp intended to be attached to the positive pole of the external power supply), and the other plate connected to the positive pole of the internal power supply.

The control circuit is connected both to the internal power supply, and to the anode clamp and cathode clamp, respectively, of the external power supply through the electromagnetic module. In the disclosed embodiment, the control circuit comprises a reversed-polarity alarm protecting circuit and correct-polarity conducting circuit.

The reversed-polarity alarm protecting circuit comprises an alarm circuit and a protection circuit in parallel connection. The alarm circuit comprises a sounding circuit and a lighting circuit, which are in parallel connection or in series connection. The sounding circuit comprises a first diode and a buzzer in series connection. The lighting circuit comprises a first LED (light emitting diode) and a current-limiting resistor in series connection. The protection circuit comprises a second diode and a photocoupler. The forward direction of the second diode is opposite to the forward direction of the first diode and the first LED.

The correct-polarity conducting circuit comprises a conduction circuit and an indicator circuit, respectively connected to the photocoupler. The conduction circuit comprises a transistor, whose base electrode is connected to the output of the photocoupler, whose collector electrode is connected to the magnetic inductor (electromagnet), and whose emitter electrode is connected to the ground. The indicator circuit comprises a second LED.

The present invention therefore provides an intellectualized polarity identification device, controlled by electromagnetic force, which ensures that the clamps of the emergency power supply are correctly connected to the positive and negative poles of the external power supply, and which prevents short circuits so as to protect the emergency power supply, the external power supply and any electrical devices connected thereto.

These and other features and advantages of the present invention will be apparent from the following detailed description and drawings in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a structural drawing of the intellectualized polarity identification device according to the principles of the present invention;

FIG. 2 is a structural drawing of the electromagnetic module of the intellectualized polarity identification device according to the principles of the present invention; and,

FIG. 3 is a circuit diagram of the intellectualized polarity identification device according to the principles of the present invention.

### DETAILED DESCRIPTION OF THE INVENTION

While the present invention is susceptible of embodiment in various forms, there are shown in the drawings and will hereinafter be described several preferred embodiments with the understanding that the present disclosure is to be considered an exemplification of the invention and is not intended to limit the invention to the specific embodiments illustrated.

It should be further understood that the title of this section of the specification, namely, “Detailed Description of the Invention,” relates to a requirement of the United States Patent and Trademark Office, and does not imply, nor should be inferred to limit the subject matter disclosed herein.

FIG. 1 displays an intellectualized polarity identification device according to the principles of the present invention. As shown in FIG. 1, the intellectualized polarity identification device preferably comprises an electromagnetic module 1 connected to a control circuit 2, and an internal power supply V which supplies power for the control circuit 2.

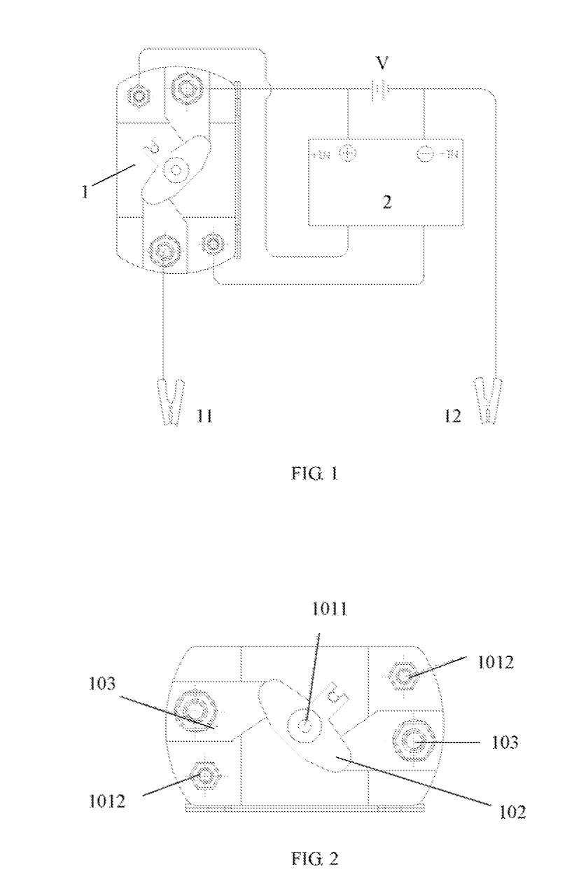

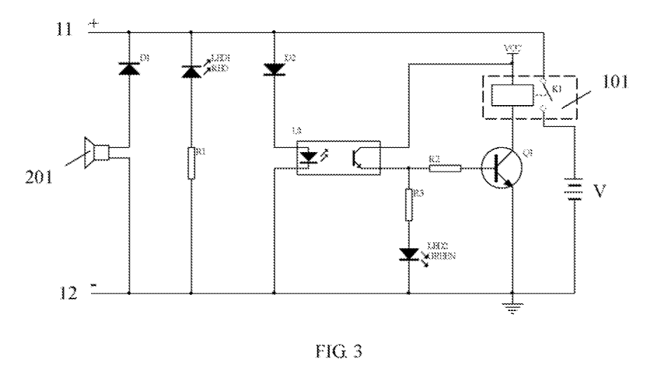

Electromagnetic module 1 comprises a magnetic inductor (electromagnet) 101 (depicted in the circuit diagram shown in FIG. 3) with a propeller or shaft 1011, as shown in FIG. 2. The lead terminals 1012 of magnetic inductor (electromagnet) 101 are connected to control circuit 2. Magnetic inductor (electromagnet) 101 and propeller or shaft 1011 are configured such that magnetic inductor (electromagnet) 101 can control the movement of propeller or shaft 1011 when magnetic inductor (electromagnet) 101 is activated and deactivated. Such configurations are known in the art as used in solenoid applications.

A movable contact plate 102, is disposed coaxially with the magnetic inductor (electromagnet) 101 and is controlled by propeller or shaft 1011 such that movable contact plate 102 moves up and down when magnetic inductor (electromagnet) 101 is deactivated and activated. That is, movable contact plate 102 moves upwards, away from and out of contact with stationary contact plates 103 (discussed below) when magnetic inductor (electromagnet) 101 is deactivated, and downwards, towards and into contact with stationary contact plates 103 when magnetic inductor (electromagnet) 101 is activated).

In the disclosed embodiment of the intellectualized polarity identification device of the present invention, electromagnet module 1 further comprises two stationary contact plates 103 fixedly disposed on electromagnetic module 1. First stationary contact plate 103 is connected to the anode (positive or “+”) clamp 11 of the intellectualized polarity identification device, and the second stationary contact plate 103 is connected to the anode (positive or “+”) pole (terminal) of internal power supply V.

As shown in FIG. 3, control circuit 2 is connected to internal power supply V and also is connected, respectively, to anode clamp 11 and the cathode clamp 12 of the intellectualized polarity identification device. Control circuit 2 comprises in the disclosed embodiment a reversed-polarity alarm protecting circuit and a correct-polarity conducting circuit.

The reversed-polarity alarm protecting circuit comprises an alarm circuit and a protection circuit in parallel connection. The alarm circuit comprises a sounding circuit and a lighting circuit in parallel connection.

In the disclosed embodiment, the sounding circuit comprises a first diode D1 (the sounding circuit diode) and a buzzer 201 in series connection. The lighting circuit comprises a first light emitting diode LED 1 (the lighting circuit light emitting diode) (preferably configured to emit a red light) and a limiting resistor R1 connected in series. The protection circuit comprises a second diode D2 (the protection circuit diode) and a photocoupler U1. The forward direction of second diode D2 is opposite to the forward direction of first diode D1 and first light emitting diode LED1.

In the disclosed embodiment, the correct-polarity conducting circuit comprises a conduction circuit and an indicator circuit, respectively connected to photocoupler U1. Conduction circuit comprises a transistor Q1 whose base electrode is connected to the output of photocoupler U1, whose collector electrode is connected to magnetic inductor (electromagnet) 101 and whose emitting electrode is connected to the ground. As shown in FIG. 2, the base electrode of transistor Q1 is connected to a regulating resistor R2 in series. The indicator circuit in the disclosed embodiment comprises a second light emitting diode LED2 (the indicator circuit light emitting diode) (preferably configured to emit a green light), which is connected to a regulating resistor R3 in series.

The operation of the intellectualized polarity identification device of the present invention will be recognized by those skilled in the art in light of the above description and the disclosures of FIGS. 1-3. Specifically, when anode (positive or “+”) clamp 11 is connected to the cathode (negative or “−”) pole (terminal) of the external power supply and cathode (negative or “−”) clamp 12 is connected to the anode (positive or “+”) pole (terminal) of the external power supply (that is, the polarity of the connection is reversed), current flows across first diode D1 and first light emitting diode LED 1, and first light emitting diode LED 1 emits red light (a visible alert) and the buzzer 201 sounds an audible alarm.

Additionally, during a reverse polarity condition, current does not flow across second diode D2 or, consequently, photocoupler U1 because of the reverse voltage. Because of this, transistor Q1 does not function, magnetic inductor (electromagnet) 101 fails to generate magnetic field, propeller or shaft 1011 cannot pull movable contact plate 102 into contact with stationary contact plates 103 and switch K1 therefore stays open. In this manner, a short circuit caused by the reversed polarity condition is avoided and the power supply and connected electric devices can be protected.

Conversely, when anode (positive or “+”) clamp 11 is connected to the anode (positive or “+”) pole (terminal) of the external power supply and cathode (negative or “−”) clamp 12 is connected to the cathode (negative or “−”) pole (terminal) of the external power supply (that is, the polarity of the connection is correct), current does not flow across first diode D1 or first light emitting diode LED1. Thus, first light emitting diode LED1 does not emit light and buzzer 201 does not produce an audible alarm.

However, current does flow across second diode D2 and photocoupler U1. Thus, second light emitting diode LED1 emits a green light (indicating normal operation) and transistor Q1 allows current to flow across magnetic inductor (electromagnet) 101, thus generating a magnetic field. The magnetic field causes propeller or shaft 1011 to retract, thereby pushing movable contact plate 102 downward towards, and into contact with, stationary contact plates 103. In this manner, switch K1 is closed thereby completing the circuit and the intellectualized polarity identification device allows the emergency power supply to form a closed circuit with the external power supply with the correct polarity.

Although the content of the invention has been given detailed introduction in the aforementioned preferred embodiment, the description shall not be taken as a restriction to the invention.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

In the present disclosure, the words “a” or “an” are to be taken to include both the singular and the plural. Conversely, any reference to plural items shall, where appropriate, include the singular.

All patents referred to herein, are hereby incorporated herein by reference, whether or not specifically done so within the text of this disclosure.

What is claimed is:

1. An intellectualized polarity identification device, comprising:
an electromagnetic module, the electromagnetic module comprising a magnetic inductor (electromagnet), a movable contact plate disposed coaxially with the magnetic inductor (electromagnet) and a plurality of stationary contact plates; and
a control circuit, the control circuit comprising a reversed-polarity alarm protecting circuit and a correct-polarity conducting circuit;
wherein the reversed-polarity alarm protecting circuit comprises an alarm circuit connected in parallel with a protection circuit, and the protection circuit comprises a protection circuit diode and a photocoupler, and
wherein the correct-polarity conducting circuit comprises a conduction circuit and an indicator circuit connected with the photocoupler.

2. The intellectualized polarity identification device of claim 1, wherein the magnetic inductor (electromagnet) further comprises includes a shaft, the shaft configured to control an up and down movement of the movable contact plate, and wherein a lead terminal of the magnetic inductor (electromagnet) is connected to the control circuit.

3. The intellectualized polarity identification device of claim 1, wherein the plurality of stationary contact plates are fixed on the electromagnetic module, and wherein one of the plurality of stationary contact plates is connected to an anode clamp and one of the plurality of stationary contact plates is connected to a “+” terminal of an internal power supply.

4. The intellectualized polarity identification device of claim 1, wherein the control circuit is connected to an internal power supply and is connected respectively to an anode clamp and a cathode clamp.

5. The intellectualized polarity identification device of claim 1, wherein the alarm circuit comprises a sounding circuit and a lighting circuit connected in parallel or series.

6. The intellectualized polarity identification device of claim 5, wherein the said sounding circuit comprises a sounding circuit diode and a buzzer connected in series.

7. The intellectualized polarity identification device of claim 6, wherein the lighting circuit comprises a lighting circuit light emitting diode and a limiting resistor connected in series.

8. The intellectualized polarity identification device of claim 7, wherein a forward direction of the protection circuit diode is opposite to a forward direction of the sounding circuit diode and the lighting circuit light emitting diode.

9. The intellectualized polarity identification device of claim 1, wherein the conduction circuit comprises a transistor having a base electrode, a collector electrode and an emitting electrode, wherein the base electrode is connected to an output of the photocoupler, the collector electrode is connected to the magnetic inductor (electromagnet) and the emitting electrode is connected to a ground, and wherein the base electrode is also connected to a regulating resistor in series.

10. The intellectualized polarity identification device of claim 1, wherein the indicator circuit comprises a indicator circuit light emitting diode and a regulating resistor connected in series.

11. An intellectualized polarity identification device, comprising:
an electromagnetic module connected to a control circuit; and
an internal power supply;
wherein the electromagnetic module comprises a magnetic inductor (electromagnet), a movable contact plate disposed coaxially with the magnetic inductor (electromagnet), and a plurality of stationary contact plates, and
wherein the control circuit comprises a reversed-polarity alarm protecting circuit connected to a correct-polarity conducting circuit.

12. The intellectualized polarity identification device of claim 11, wherein the magnetic inductor (electromagnet) (101) comprises a shaft, the shaft configured to control an up and down movement of the movable contact plate, and wherein a lead terminal of the magnetic inductor (electromagnet) is connected to the control circuit.

13. The intellectualized polarity identification device of claim 11, wherein the plurality of stationary contact plates are fixed on the electromagnetic module, and wherein one of the plurality of stationary contact plates is connected to an anode clamp and one of the plurality of stationary contact plates is connected to a “+” terminal of the internal power supply.

14. The intellectualized polarity identification device of claim 11, wherein the control circuit is connected to the internal power supply and is connected respectively to an anode clamp and a cathode clamp.

15. The intellectualized polarity identification device of claim 14, wherein the reversed-polarity alarm protecting circuit comprises an alarm circuit connected in parallel with a protection circuit.

16. The intellectualized polarity identification device of claim 15, wherein the alarm circuit comprises a sounding circuit and a lighting circuit connected in parallel or in series, wherein the sounding circuit comprises a first diode and a buzzer connected in series and the lighting circuit comprises a first light emitting diode and a limiting resistor connected in series.

17. The intellectualized polarity identification device of claim 16, wherein the protection circuit comprises a second diode and a photocoupler, wherein a forward direction of the second diode is opposite to a forward direction of the first diode and the first light emitting diode.

18. The intellectualized polarity identification device of claim 11, wherein the correct-polarity conducting circuit comprises a conduction circuit and an indicator circuit respectively connected to the photocoupler.

19. The intellectualized polarity identification device of claim 18, wherein the conduction circuit comprises a transistor having a base electrode, a collector electrode and an emitting electrode, wherein the base electrode is connected to an output of the photocoupler, the collector electrode is connected to the magnetic inductor (electromagnet) and the emitting electrode is connected to a ground, and wherein the base electrode is also connected to a regulating resistor in series.

20. The intellectualized polarity identification device of claim 18, wherein the indictor circuit comprises a second light emitting diode connected in series with a regulating resistor.
